(19) United States
(12) Patent Application Publication
(10) Pub. No.: US 2008/0317553 A1
(43) Pub. Date: Dec. 25, 2008

(54) METHOD FOR RECYCLING OF SYNTHETIC MATERIAL CONTAINING WASTE

(76) Inventors: Jost-Ulrich Kugler, Essen (DE); Peter Belouschek, Mullheim an der Ruhr (DE); Katja Kugler, Essen (DE)

Correspondence Address: RENNER, OTTO, BOISSELLE & SKLAR, LLP, Nineteenth Floor, 1621 Euclid Avenue, Cleveland, OH, 44115-2191, US

(21) Appl. No.: 12/122,230

(22) Filed: May 16, 2008

(30) Foreign Application Priority Data
May 18, 2007 (EP) 07 009 927.0

(51) Int. Cl. B09B 3/00; B02C 23/00

(52) U.S. Cl. 405/129.1; 241/25; 241/24.1; 405/129.2; 405/129.95

(57) ABSTRACT

The present invention relates to a method for recycling of synthetic material containing waste. In the process initially in a first step the synthetic material containing waste is crushed to a particle diameter ≦100 mm and then admixed as aggregate in a soil material, in particular in a silt containing soil for the earthworks. The portion of the synthetic material containing waste admixed in the second step is preferably 15 percent by volume to 70 percent by volume. The resulting soil material is in many aspects excellently suited for the earthworks and in particular, for the recultivation or the protection of problematic landfill areas.

### 1. TECHNICAL FIELD

The present invention relates to a method for recycling of synthetic material containing waste.

### 2. PRIOR ART

Synthetic material containing wastes are a great waste disposal problem. This holds for highly developed societies with well established waste disposal concepts as well as also for developing countries without any infrastructure for the waste disposal.

The usual approach is the incineration of such wastes. However, in this process even in the case of an optimized incineration in a modern plant a very large quantities of CO₂ emissions harmful to the climate are generated as is shown by the following estimation: At a usual content of approximately 50% to 70% of TOC (saturated total organic carbon) of the synthetic material containing waste at the oxidation (incineration) the following reaction takes place: C+O₂→CO₂. Taking into account the atom masses of the involved elements carbon (12) and oxygen (16) this results in a factor of 3.66, i.e. the incineration of a ton of synthetic material containing waste with a content of 50% to 70% of saturated organic carbon leads to an emission of 1.83 t to 2.56 t of carbon dioxide.

In addition, in waste incineration plants often overheating arise due to the addition of well inflammable synthetic material containing waste which the waste incineration plants to do not tolerate. In this case additionally wet sewage sludge is inserted for extinguishing or for lowering the incineration temperatures, respectively, causing further significant CO₂ emissions harmful for the climate of approximately 1.1 tons per ton of wet sewage sludge (TS 25 to 30).

In the southern parts of Europe and in Africa waste with increased portions of plastics, foils and synthetic material residues are often not even incinerated in adequate plants, but the material is stored, smoulders or incinerates on landfills together with other rubbish. Protections and recultivations of such landfills can not be done by many countries in these regions from cost and know how reasons.

The present invention is therefore based on the problem to represent a general method for the recycling of such waste which avoids on the one hand the above-mentioned effects harmful for climate and enables on the other hand an environmentally friendly and cost effective recycling in the earthworks. Thereby at least some of the above mentioned disadvantageous detrimental to the environment can be avoided. The various soil mechanical properties allow a use in soils depending of the particle size of the recycled, synthetic material containing waste with manifold positive applications.

### 3. SUMMARY OF THE INVENTION

According to an embodiment of the present invention this problem is solved by a method according to patent claim 1. Correspondingly, in a first step the synthetic material containing waste is crushed to a particle diameter ≦100 mm and then admixed as aggregate in a soil material, in particular a silt containing soil for the earthworks. The portion of the synthetic material containing waste admixed in the second step is preferably 15 percent by volume to 70 percent by volume. The resulting soil material is excellently suited in multiple aspects for the earthworks and in particular for the recultivation or the protection of problematic landfill areas.

Since crushed substrates of synthetic materials or biologically treated wastes of mechanical and biological waste treatment plants do not have any negative impairment for the environment, the proposed application of synthetic material containing waste in the earthworks is completely environmentally compliant. This is confirmed by the already known applications of synthetic materials in the construction and agricultural sectors as well as for packaging of food.

### Plastic Material Containing Waste for Recultivation

In an embodiment, the synthetic material containing waste is initially crushed by cutting, tearing and/or grinding so that a composite arises with a particle diameter ≦45 mm. This is suited to treat sludge or solid, heavy, clay containing silts to become top soils which are highly permeable to air that are otherwise not usable or only restrictedly useable for recultivation.

It is an important advantage of these exemplified treated materials and additives in soils that by the additional insertion of treated waste containing synthetic material in recultivation soils for increasing permeability of air at the same time an increase of the permeability for water does not occur, but on the contrary, a water retaining, partly a water blocking function is achieved. The addition of approximately 30 percent by volume of crushed synthetic material containing waste with a granulation diameter of 0/36 mm in silt containing top soils (silt portion approximately 25%) shows after a slight compaction that the coefficient of permeability is k=2 to 3×10⁻⁸ m/s. Nevertheless, a good air permeability is provided with open air pores >15%. Without the addition of crushed synthetic material wastes the value of k of usually used top soils is >1×10⁻⁷ m/s.

### Synthetic Material Containing Waste for Sealing

In a further embodiment, a sieving is also carried out to a particle size d≦16 mm, in particular d≦8 mm, wherein the synthetic material containing waste contains in the first step by grinding and tearing a dust portion of 2 percent by weight to 5 percent by weight with a particle diameter <0.06 mm and a fine portion of 5 percent by weight to 10 percent by weight with a particle diameter <2.0 mm. This material can be applied in sandy sludges as an aggregate with 20 percent by volume to 30 percent by volume as a water storing and sealing layer by blocking the soil pores.

In an other embodiment, a sand soil with a silt portion of 20% and a sand portion of 80% which is sodium silicate coated results after a compaction to 100% of Proctor density in a coefficient of permeability of k=3 10⁻⁹ m/s. In contrast, the same soil with crushed synthetic material containing waste (addition quantity 30 percent by volume, particle diameter 0 mm to 10 mm) has a coefficient of permeability of k=2 to 1×10⁻¹⁰ m/s. The soil is predominantly hydrophobic.

A further large field of application is the protection of not burning landfills in the Mediterranean region. In these regions only sedimentary rocks are available for landfill protections, since cohesive soil is strongly required for recultivation and as agricultural areas due to its low thickness. It is known that stones which are broken and milled to a particle size 0/16 mm with an aggregate of hydraulically linking ashes or dusts and a composite water content of approximately 20% by compaction result in a coefficient of permeability of k_{f}≧1×10⁻⁸ m/s to 5×10⁻⁹ m/s. Such sealing layers are used for the protection of burning dumps due to their heat resistance.

For household waste landfills, the coefficient of permeability is considered to be k_{f}≧1×10⁻⁹ m/s according to the European norm for the final protection of a mineral surface sealing. The addition of the above mentioned crushed synthetic material containing waste with a granulation diameter of 0/10 mm with 20 percent by volume to 30 percent by volume results after mixing of the broken rock composite and the hydraulically linking ashes and after compaction to a Proctor density of 97% in a coefficient of permeability of k_{f}≧1×10⁻¹⁰ m/s so that also in regions without deposits of silt and clay high quality mineral sealing layers can be generated environmentally friendly and extremely cost effective for the protection of landfills with the rock formations locally available.

### Synthetic Material Containing Waste for Light Stabilisation Layers and Blocking Layers

In a further embodiment, the method comprises the step of linking the synthetic material containing waste with 50 percent by weight to 70 percent by weight with hydraulically linking ashes and/or dusts and/or sludges with a subsequent compaction of the soil material to an erosion resistant protection layer and blocking layer. This compaction leads preferably to a density in moist condition of γₘₒᵢₛₜ=1.2 t/m³ to 1.5 t/m³ or to density in dry condition of γ_{dry}=0.9 t/m³ to 1.2 t/m³. At the same time, for hydrophobicity a value of k of 5×10⁻⁹ m/s is reached on average. Such a soil material can be applied as structural stable cover soil for the surface protection of slurry ponds, landfills or dumps, in particular with slope gradients of 35° to 45°. In doing so, the thickness of the compacted cover soil is preferably 0.20 m to 1.00 m. As a result, for example structural stabilities of steep slopes of potash dumps with slope gradients of approximately 40° and a height of more than 200 meters can be realized for the first time with planting vegetation to protect against penetrating rain water.

### Synthetic Material Containing Waste for Volume Stability

Furthermore, by the addition of 20 percent by volume to 40 percent by volume of synthetic material containing waste with a particle diameter ≧10 mm of synthetic material containing waste, for example in cohesive soils with a silt portion ≧40 percent by weight, a particle diameter <0.06 mm and a subsequent compaction to a Proctor density of 100%, shrinkages do not occur during drying so that the material has a high degree of volume stability. In contrast, without the addition of treated synthetic material wastes, for example silt soils shrink by 7 percent by volume to 15 percent by volume and clay containing soils with a clay portion of >10 percent by weight and a particle diameter <0.002 mm by ≧15 percent by volume to 20 percent by volume.

Drying or dehydration, respectively of mineral sealing soils usually results in cracks that cancel the sealing effect. Against this, according to the prior art, sealing systems are superimposed with reinforcing meshes or sealing systems with a superimposed floating soil of the soil class DIN 18 300, class 2, floating soil type for a self-repairing effect which limits the structural stability of slopes.

Alternatively to mineral sealings, also top soil layers with a thickness of 1.50 m to 2.00 m are applied to landfill surfaces with high sorption behaviour against rain water so that by the soil of 2.00 m thickness a rejection of rain water against the body of the landfill should occur. The problem of the crack formation due to dehydration can however be avoided by the addition of crushed synthetic material containing waste, preferably of a granulation diameter of 0/45/56 mm. The homogeneously inserted substrates have a reinforcing effect to the soil and avoid crack formation during dehydration. By means of their water retaining effect mentioned above in the treated cohesive soil, they also avoid formation of cracks during dehydration and during remoistening what otherwise significantly restricts the sorption effect of water.

Cohesive top soils with little compaction have coefficients of permeability of k≈1×10⁻⁷ m/s. After drying and remoistening dry crack formations occur and after the remoistening the coefficient of permeability is in the range of k=1×10⁻⁵ m/s to 1×10⁻⁶ m/s. If into the same soils the above mentioned synthetic material containing waste substrates are admixed, they keep their hydrophobic effect in the order of magnitude of k=1×10⁻⁸ m/s to 6×10⁻⁹ m/s.

The synthetic material containing waste used in the mentioned methods can contain wastes of household waste, commercial waste, and industrial waste, and/or from mechanical biological waste treatment plants as well as sand residues resulting from sorting by sieving or construction composite waste, and/or faulty badges of the production. As a result, these wastes can therefore be recycled globally, environmentally compliant in very large quantities for recultivations in moderate or hot climatic zones, or for special protection layers in the earthworks to support the groundwater protection for protection layers as valuable substitution material instead of silt and clay.

Further embodiments of the inventive method are defined in further dependent patent claims.

### 4. SHORT DESCRIPTION OF THE DRAWING

FIG. 1: A schematic representation of a soil construction with plant substrates and treated synthetic material containing wastes for recultivation of desert regions.

### 5. DETAILED DESCRIPTION OF PREFERRED EMBODIMENTS

In the following initially fields of application of the inventive method are generally explained then special embodiments are exemplified for consolidation. It shall be understood that aspects of an individual embodiment can also be applied in other embodiments even if this is not explicitly mentioned. On the other hand not all features of the method explained in the context of a following embodiment are mandatory for the execution of the method.

In the course of the worldwide required climate protection and of the environmental regulations enforce in individual countries that contaminated lands and landfills have to be recultivated. This applies for moderate climatic zones, as for example Central Europe, as well as for arid regions such as South Europe or for large parts in Africa or Asia. In particular, significant efforts have to be done to implement in a big scale in the arid desert regions/steep regions recultivation measures for agricultural plantations, bush plantations, and forest plantations with available or artificial soil composites.

Especially in Germany, the salt insertion of the Rhine and Werra by the approximately 200 m high salt dumps with slope gradients of approximately 40 percent is a problem. Up to now, these dumps could not be stably covered with soil and vegetated against eluviations by rainfall, since protection soils and suitable wastes are not available to the desired extent and the needed quality for pouring and for regrading the slopes with a subsequent sealing of the surface.

All in all, it is therefore required to develop for such protection and recultivation measures special artificial soils solving these problems of the recultivation and the required protection needed for this purpose.

### 1. Recultivation Measures in Moderate Climatic Zones

For recultivation of dumps or landfills artificial soil substrates from available silt containing sandy soils with additive of treated composted lopping and minor aggregate of sewage sludge or water sludge (10 to maximum 20 percent by weight) are added so that in each case applicable analytical conditions for the environmental protection for the recycling of the artificial top soil are obtained to support groundwater protection and soil protection. Often top soil composites with a thickness of >2.0 m are applied for the protection of former landfills or dumps instead of surface sealing systems under the assumption that these sorptively retain the incidental rain falls without infiltration through the soil.

However, large scale model tests have revealed that in periods without vegetation, despite these thick top soil coverings still significant amounts of water of up to 20% to 30% of the rain fall are infiltrating through an approximately 2.0 m thick top soil in periods without vegetation. This results simply from the fact that top soils lose in the course of the time their sorptive properties and gets penetrable due to the climatic changes and the changes in the water content from almost water locked until dry (winter and summer).

The above mentioned method according to an embodiment of the invention can avoid this. The insertion of approximately 15% to 35% of synthetic material substrate with a particle diameter of 0/45 mm shows dependent from the pore portion of the top soil that this soil maintains its water storing and retaining properties in support of the sorption in the dry as well as in the wet condition. In contrast, in top soils which are not admixed with synthetic material substrates the coefficient of permeability reduces from approximately k=1×10⁻¹⁰ m/s to 1×10⁻⁷ m/s after several changes from wet to dry to coefficients of permeability of k≦10⁻⁸ m/s to 10⁻⁷ m/s.

Therefore, after a biological treatment material substrates from mechanical biological waste treatment plants can be applied for general recultivation measurements as loosening composite, since they result in a good soil aeration with open air pores ≧15% when admixed in an order of magnitude of 15 percent by volume to 35 percent by volume—in particular at silty, strongly cohesive soils (silt portion ≧30%, particle diameter <0.06 mm)—and since they have permanently water retaining properties when applied as 1.50 m to 2.00 m thick top soil layers instead of mineral sealings.

In addition, the admixture of synthetic material substrates in top soils improves the structural stability since it leads to increased sheering resistances. The sheering resistance of a top soil is usually φ_{E}=28° to 33°. By inserting of 30 percent by volume of synthetic material substrates this value increases to φ_{E}=38° to 42°. The synthetic material substrates have reinforcing properties in the soil. The size of the substrates has to be determined separately depending from the soil type and the problem. For recultivation on fill slopes, substrates with a particle diameter of 60/100 mm can replace traceries or expensive claw layers of PE or HDPE. Therefore, also top soil layers can be applied structural stably as sealing layer over mineral sealings without protection measurements on slopes with gradients of 1:1.5 also with a low thickness of d=0.20 m to 1.00 m.

2. Protection of Dumps and Landfills with High and Steep Slopes

The improved stability is of significant relevance particularly at the protection of steep dumps, as for example potash dumps. Typically potash dumps have dimensions of approximately 1,000 m width up to 1,500 m length with a height of >200 m. Thus, the slope gradients are approximately 40°. The impact of rainfalls and lixiviation of the deposited salts results in an increased salt insertion into the ground water and to the river in the sphere of influence. By wind degradation significant ecological damage in the surrounding region occurs. A save covering of potash dumps with soil for recultivation have not been reached up to now, despite of more than 10 years of research and development activities. All of the recultivation measurements in the so-called “thin bed method” have failed. A covering and recultivation by suitable pouring to flatten the slopes is not possible since there is on the one hand not sufficient land available and on the other hand the masses of soil needed for a regrading of high slopes do not exist.

However, by the application of an embodiment of the above mentioned method a covering soil for potash dumps can artificially be made fulfilling the requirement of the structural stability and having at the same time hydrophobicity and erosion reliability and enables yet the recultivation by mixing in advance seeds in the surface region of the stabilization layer.

A well compactable artificial soil composite results from
synthetic material substrates of on average 70 percent by volume of the particle diameter 0/45 mm or a diameter 0/56 mm, respectively
and 20 percent by volume of dredged material, water sludge or sewage sludge (TS 25 to 30, or TS 25 to 70)
and 10 percent by volume of sand, such as foundry sands, sieved sorting sand or treated waste incineration slag with a particle diameter of 0 mm to 8 mm
   and a subsequent stabilization with 15 percent by weight to 30 percent by weight on average 20 percent by weight percent (referred to the above mentioned material composite) of hydraulically cohesive ashes and dusts or boiler slags, wherein the resulting composite has the following properties:

| | | |
|---|---|---|
| 1. | light-weight in moist condition | γₘₒᵢₛₜ = 1.2 t/m³ to 1.4 t/m³ |
| 2. | light-weight in dry condition | γ_{dry} = 0.9 t/m³ to 1.05 t/m³ |
| 3. | with high structural stability: | φ′ < 40° |
| | friction angle | |
| 4. | and effective equivalent friction | S_{E} ≧ 45° |
| | angle of | |
| 5. | compressive strength | after 3 days |
| | | qᵤ ≧ 150-200 kN/m² |
| | | after 7 days up to 400 kN/m² |
| 6. | permeability | k_{f} < 1 × 10⁻⁸ m/s |
| 7. | volume stable also after 8 weeks of | |
| | storage in water | |

The high overall sheering resistance is exclusively based on the use of synthetic material containing waste as soil by filling of the waste pores with water containing sludge which is additionally stabilized by hydraulically linking ashes and dusts. In this connection, in particular the minimization of the aggregates sludge to ≦20 percent by weight to 30 percent by weight, broken sand to ≦10 percent by weight 15 to percent by weight is especially important. A too high admixture of the pores of the synthetic material containing substrates results in unfavourable values. The synthetic material particles act as fibre reinforcements in the soil. In addition, the compacted composite has hydrophobic functions so that capillary ascending chlorides are retained by covering the soil on the salt dump with an approximately 40 cm thick layer. The stability of the layer on potash dumps with thicknesses of 40 cm to 60 cm can be realized in particularly due to the light weight and the high overall sheering resistance and the reinforcing effect. The application of artificial soils on the steep slopes with compaction can be done by earthworks machines guided on wires which are suitable for steep slopes. For this purpose, the construction heap heights are 30 cm to 40 cm. Moreover, these layers have a good fertility for the grass seed. There is the possibility to mix the corresponding seeds to a special layer and to apply to the protection layers by means of slight rolling.

From the natural soil mechanics a soil with such properties is not known. Only by such an artificial soil it is possible to recultivate and to protect economically the mentioned potash dumps.

### 3. Recultivation of Desert Areas and Arid Climatic Zones

In arid areas suitable sludges or composts are admixed in for manuring or water sustainment, respectively to the predominantly permeable sandy soils. In the course of the world wide climatic change by the increase of hot periods and dry periods in all climatic zones these soil layers however cure and thereby losing partly their water retaining effect by drying and remoistening so that as a result a lot of water drains away.

A further problem is that in areas adjacent to deserts only inorganic sandy soils are available with high water permeability. These sandy soils contain in the most regions salts in different concentration. In these areas, there is water shortage. At common irrigation of the plants large quantities of water are lost by evaporation and drain away. At the drain away the salts available in the desert soil are solubilised. They ascend capillary and are then retained in the root zone. For this reason plantings are not permanently maintainable in desert areas. The plants are also often destroyed by wind erosion.

Therefore, the planting is only permanently maintainable if the quantity of water can be reduced to a minimum despite the great heat and if the drain away of the watering water can be avoided. Therefore, below the planting a protection layer against drain away and ascending salt is required.

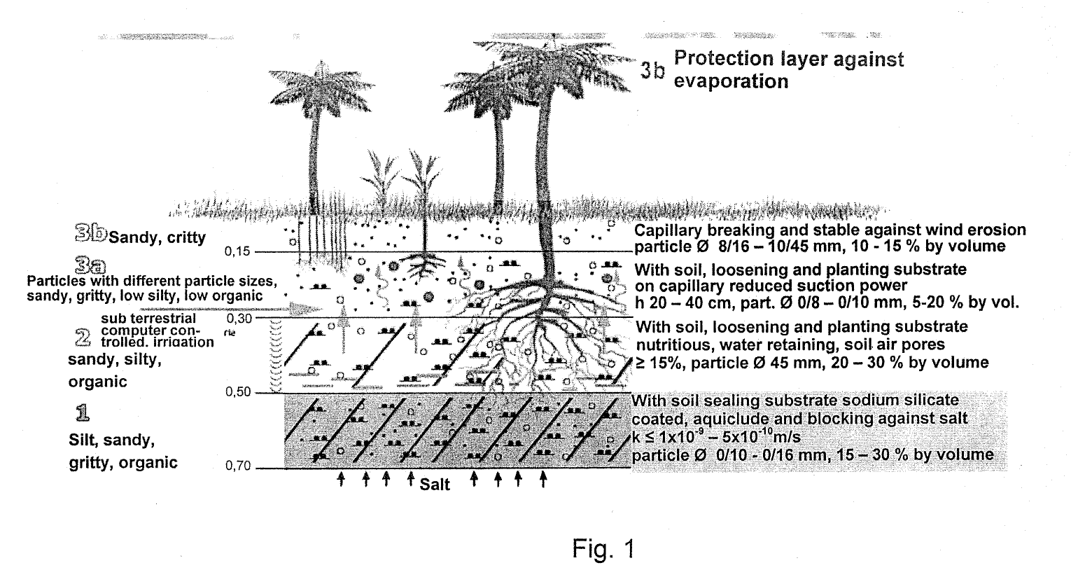

By applying an embodiment of the above mentioned method to achieve these soil properties, top soils have to be produced approximately 60 cm to 80 cm below the ground level preferably with a layer composition as schematically presented in FIG. 1, which is explained in the following:

The lowest layer 1 should preferably be tight, i.e. water retaining against drain away and blocking against ascending salt. The insertion of synthetic material substrates with 15 percent by volume to 30 percent by volume at a particle diameter of 0/10 mm to 0/16 mm into the soil composite with organic composted waste or sludge with 15 percent by weight to 30 percent by weight of available sandy soil with 70 percent by weight to 85 percent by weight results in a sealing layer with a coefficient of permeability of k=1×10⁻⁹ m/s to k≦5×10⁻¹⁰ m/s, if the soil composite produced in such a manner is additionally compacted in layer thicknesses of approximately 30 cm with a vibration roll with flat outer cover, roll weight 7 t to 10 t in three times operation.

The overlying layer 2 has to contain organic material, nutritious, loosely, highly permeable for air, but retaining water. The aggregate of synthetic material sub-strate of 20 percent by volume to 30 percent by volume of granulation diameter 0/45 mm in the above mentioned soil composite without compaction results in loosening for air permeability and at the same time in high water maintainability.

Above that, there is a plant protection layer 3a with an overlying soil layer 3b against erosion. These are predominantly available soils which are treated as follows:
lower zone 3a: the capillary ceiling of the available sandy soils interspersed with dust from the desert is approximately 60 cm to 100 cm. As a result of this, significant quantities of water would evaporate, since the capillary ceiling extends to the surface. By the specifically admixture of synthetic material substrates of 5% to 20% with a granulation diameter of 0/10 mm the capillary ceiling can be reduced to ≦20 cm to 40 cm depending from the needed ceiling for moisture acceptance from the layer 2 for young first planting, cf. FIG. 1;
upper zone 3b: capillary breaking layer by grains of the same size and sun protection and erosion protection, sand soil filled with 20 percent by volume to 30 percent by volume with synthetic material substrates, particle diameter 8/16 mm or 10/45 mm and approximately 10 percent by weight to 15 percent by weight of hydraulically linking ashes or dusts results in a semi-rigid protection layer which is capillary breaking and erosion protected against wind degradation by can be penetrated by plants.

### 4. Generation of Sealing Layers in Hot Climatic Regions of Southern Europe or Africa

In the course of the generally required climatic protection, African countries, for example Nigeria systematically migrate to a waste management for recycling, this should in particular restrict the European solution for waste incineration in favour of the climate protection. There also exist similar approaches in European countries. In Southern Europe, there is a lack of silt and clayed soils with which base or surface sealings can be generated. Up to now, silt containing sand soils or treated sedimentary rocks do not have the desired density of k<1×10⁻⁹ m/s for surface sealings and of 5×10⁻¹⁰ m/s for base seals.

However, in the southern parts of Europe and in Africa the waste contains increased portions of plastic, foils and synthetic material residues of the packaging which are at the moment almost exclusively stored, smoulder or burn on mono landfills together with rubbish. In addition, in contrast to Europe and North America, for example in Nigeria takes efforts in the direction to not exclusively use flat roll foils of HDPE materials for the production of base seals or surface seals with foreign know-how. Rather it is intended to construct own durable seal layers with the resources available in the country.

For this purpose, the developed sealing technique with cohesive mixed and sandy soils by means of sodium silicate coating is suitable. Adequate coefficients of permeability of k<5×10⁻¹⁰ m/s are only achieved if the silt portion with a particle diameter of ≦0.06 mm is ≧40%. But there exist only sandy soils with a silt portion of 15% to a maximum of 25%. In these soils sealing quantities of only k=5 to 3×10⁻⁹ m/s have been obtained by means of the sodium silicate coating and by a corresponding compaction.

The mixture of these soils with synthetic material waste of particle diameter of 0/8 mm to 0/10 mm, addition of 25 percent by volume to 30 percent by volume results at the same soil application and by sodium silicate coatings in coefficients of permeability of up to k_{f}=1×10⁻¹⁰ m/s. These values have been constant over an observation period of half a year even at an additional impoundment of landfill drain water. Thereby, it is shown that also manually sorted and subsequently crushed synthetic material wastes can be economically and appropriately applied for sealing purposes in the base region and for surface sealings in Africa and Southern Europe.

1. A method for recycling of synthetic material containing waste in the earth works with the following steps:
a. crushing of the synthetic material containing waste to a particle di-ameter 100 mm; and
b. admixing of the crushed synthetic material containing waste as aggregate into a soil, in particular a silt containing soil.

2. The method according to claim 1, wherein the portion of the synthetic material containing waste admixed in step b. is 15 percent by volume to 70 percent by volume in the soil after step b.

3. The method according to claim 1, wherein the synthetic material containing waste is crushed in step a. by cutting, tearing and grinding so that the substrate composite has in a particle diameter=45 mm.

4. The method according to claim 3, wherein the portion of the admixed syn-thetic material containing waste after the step b. is 15 percent by volume to 35 percent by volume and wherein the soil applied in step b. has a silt portion=15% at a particle diameter <0.06 mm of the silt before the admixture.

5. The method according to claim 1, wherein step a. further comprises a step of sieving to a particle diameter=16 mm, preferably to a particle diameter=8 mm.

6. The method according to claim 5, wherein the synthetic material containing waste in step a. further comprises by grinding and tearing dust portions of 2 percent by weight to 5 percent by weight with a particle diameter <0.06 mm and fine portions of 5 percent by weight to 10 percent by weight with a particle diameter <2.0 mm.

7. The method according to claim 2, wherein the synthetic material containing waste in step a. is crushed to a particle diameter of 0/10 mm to 0/16 mm and the soil comprises after step b. synthetic material containing waste of 15 percent by volume to 30 percent by volume and the soil comprises prior to the admixing in step b. organically composted waste or sludge with 15 percent by weight to 30 percent by weight, and sandy soil with 70 percent by weight to 85 percent by weight.

8. The method according to claim 1, further comprising the step of linking the synthetic material containing waste with hydraulically cohesive ashes and slags and/or dusts and/or sludges with subsequent compaction of the soil material.

9. The method according to claim 8, wherein the subsequent compaction leads to a density in moist condition of ?moist=1.2 t/m3 to 1.5 t/m3 or a density in dry condition of ?dry=0.9 t/m3 to 1.2 t/m3.

10. The method according to claim 9, wherein in step a. the synthetic material containing waste is crushed to a particle diameter 0/45 mm or a diameter 0/56 mm and the soil contains after step b. on average a synthetic material containing waste of 60 to 80 percent by volume, dredged material, water sludge or sewage sludge of 15 to 25 percent by volume, and sand of 5 to 15 percent by volume with a particle diameter of 0 mm to 8 mm, wherein the synthetic material containing waste has a reinforcing function to sup-port the structural safety and the safety against sliding.

11. The method according to claim 10, further comprising a stabilisation step by mixing the prepared soil after step b. with hydraulically linking ashes, dust and slags of 15 percent by weight to 30 percent by weight.

12. The method according to claim 8, further comprising the step of applying the soil material as stable cover soil for the surface protection of slurry ponds, landfills or dumps, in particular with slope gradients of 35° to 45°.

13. The method according to claim 11, wherein the thickness of the compacted cover soil is 0.20 m to 1.00 m.

14. The method according to claim 1, wherein the synthetic material containing waste comprises waste from household waste, commercial waste and industrial waste and/or waste from mechanical biological waste treatment plants, residues from sorted sieving sands respectively construction composite waste, and/or from faulty batches of productions.
